(19) United States
(12) Patent Application Publication
(10) Pub. No.: US 2005/0008030 A1
(43) Pub. Date: Jan. 13, 2005

(54) Procedure for exchanging useful information generated according to different coding laws between at least 2 pieces of user terminal equipment

(76) Inventors: Klaus Hoffmann, Munchen (DE); Sven Sabrowski, Munchen (DE); Jean-Marie Stupka, Germering (DE)

Correspondence Address: Siemens Corporation;Intellectual Property Department, 170 Wood Avenue South, Iselin, NJ, 08830, US

(21) Appl. No.: 10/497,112

(22) PCT Filed: Nov. 13, 2002
(86) PCT No.: PCT/DE02/04200

(30) Foreign Application Priority Data
Nov. 27, 2001 (DE) 10158059.2

(51) Int. Cl. H04J 3/16

(52) U.S. Cl. 370/466

(57) ABSTRACT

If TDM connections are through-connected from the originating TDM network to the target TDM network via a data network in the form of backbone, e.g. VoIP, the switchover between the TDM network and the data network takes place via media gateways. As is the case with connections exclusively between TDM, the coding algorithms of the A face and the B face have to be identical. In TDM networks, coding is done according to A Law and μ Law. When switching from an A Law network to a μ Law network, the coding specifications have to be converted. In order to carry out a conversion in a TDM environment, at the switchover point the μ Law face has to convert to A Law. The same applies to VoIP. The invention relates to the integration of this switchover conversion rule in the codec negotiation procedure so that in principle a μ Law A face offers μ Law and, alternatively, A-Law to the B face; a μ Law B face accepts μ Law whereas an A-Law B face acknowledges A-Law. Furthermore, 64 kBit/s unrestricted preferred connections are considered in fall back mode, wherefore an additional logic is integrated into the codec modification procedure by means of which in principle μ Law and, as an alternative, A-Law are offered to the B face in addition to the transparent CODEC or instead of offering a μ Law A face to the TMR only. The B face first accepts the transparent CODEC on the basis of the list or the TMR ‘64 kBit/s unrestricted preferred’. When receiving the TMU, the B face selects the Codec to satisfy the code conversion rule.

### CROSS REFERENCE TO RELATED APPLICATIONS

This application is the US National Stage of International Application No. PCT/DE02/04200, filed Nov. 13, 2002 and claims the benefit thereof. The International Application claims the benefits of German application No. 10158059.2 filed Nov. 27, 2001, both of the applications are incorporated by reference herein in their entirety.

### FIELD OF INVENTION

The invention relates to a procedure for exchanging useful information generated according to different coding laws between at least 2 pieces of user terminal equipment.

### BACKGROUND OF INVENTION

More recent communication architectures separate switching networks into call feature servers and transport useful information (bearer control). Therefore, useful information can be transmitted via the different high-bit rate transport technologies such as ATM, IP or frame relay.

With such a separation, telecommunications services transmitted in present narrowband networks must also be provided in broadband networks. In this case, the users are either connected directly (e.g. via a DSS1 protocol) or via switching centers (e.g. via the ISUP protocol) embodied as call feature servers (CFS). The useful information is converted via media gateways (MG) to the transport technologies used in each case.

The control of the media gateways is in each case carried out by assigned media gateway controllers which can be embodied as call feature servers. In order to control the media gateways, the call feature servers use standardized protocols such as the MGCP protocol or the H.248 protocol. For purposes of intercommunication, the call feature servers use a standardized BICC (Bearer Independent Call Control) protocol that represents the further development of an ISUP protocol.

The BICC protocol uses the Q.765.5 BAT (bearer application-transport) ITU-T standard protocol which also describes the RTP as bearer technology for IP bearers. This protocol is used for resource problems in the network that are solved by compressing the data. For this, a CODEC negotiation procedure is provided that forms part of the Q.765.5 BAT protocol.

An instruction manual on how to use this protocol provides in a further BICC protocol, the Q.1902.x BICC CS2 protocol (bearer independent call control capability set 2 with its own service indicator in the MTP (Message Transfer Part)) which is being used as an ITU-T standard.

By using this protocol, for example, the useful information transmitted previously between 2 PSTN networks is transmitted via an IP network. In this case, for the transmission via the IP network, the signaling information and the useful information are separated. Therefore, problematical is the condition that the Q.1902.x BICC CS2 ITU-T standard does not consider the problem if the user of an A-law country would like to establish a connection to a user set up in a μ-law country. Because in this case the information exchanged between both users is generated according to different coding laws, the danger of falsifying the useful information exists. This problem particularly comes to the fore in the case of transborder telephones (e.g. Europe (A-law)—USA (μ-law)).

This particularly also applies to 64 kBit/s unrestricted preferred connections in the fall back mode. In principle, in the case of 64 kBit/s connections, the coding/decoding is carried out in the terminal equipment. The useful information transmitted via this connection is routed transparently through the network. For a 64 kBit/s unrestricted preferred connection, the calling A subscriber is ready to accept a connection with a low bandwidth should the connection not be established. This can be a normal speech connection or a 3.1 kHz connection.

These problems did not occur in the analog connections used until now.

### SUMMARY OF INVENTION

The object of the invention is to show a way in which useful information that is generated according to different coding laws can be exchanged package-oriented.

The object of the invention is solved by the claims.

One advantage of the invention is the fact that an efficient coding/decoding is carried out when switching over from the μ-law to the A-law while the CODEC negotiation procedure already existing in the Q.765.5 BAT protocol is extended by an additional logic. This ensures that the correct coding procedure is selected. With this additional logic for the correct selection of the Codecs, a switchover between the A-law and the μ-law coding firstly takes place. The additional logic transmits the transcoding rule for VoIP connections specified in the ‘TDM world’.

Another advantage of the invention is the fact that an efficient coding/decoding also takes place for fall back connections when switching over from the μ-law to the A-law while the CODEC negotiation procedure already existing in the Q.765.5 BAT protocol is extended by an additional logic.

Advantageous further developments of the invention are given in the subclaims.

### BRIEF DESCRIPTION OF THE DRAWINGS

The invention is explained in greater detail below on the basis of the preferred embodiments and the accompanying drawings.

They are as follows:

FIG. 1 a network configuration in which the procedure according to the invention is implemented,

FIG. 2 the algorithm according to the invention for the speech connections

FIG. 3 the algorithm according to the invention for 64 kBit/s unrestricted preferred connections

### DETAILED DESCRIPTION OF INVENTION

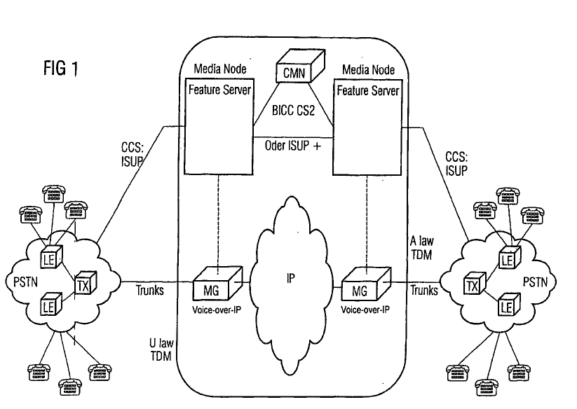

FIG. 1 shows a network configuration in which the procedure according to the invention takes place. Accordingly, 2 PSTN networks are shown in which several users are arranged in a well-known way in each case. These are routed to local switching centers LE that, on their part, are connected to transit switching centers TX.

Therefore, in the transit switching centers TX, the signaling information is separated from the useful information. The signaling information is fed directly from the transit switching center TX (ISUP protocol) to a media gateway controller CFS. The useful information is fed to a (arranged on the input-side) media gateway MG A that functions as an interface between the TDM network and a transmission network IP. The useful information is transmitted package-oriented via the transmission network IP. The media gateway controller CFS A that is embodied as the call feature server controls the media gateway MG A.

The useful information is routed from the media gateway MG A to a further (arranged on the output side) media gateway MG B via the transmission network IP. Here, the useful information is again converted to a TDM data flow by controlling the media gateway MG B (arranged on the output side) to which a feature server CFS B is assigned, and fed to the user coming into question.

A standardized protocol supports the data transmitted between a call feature server and the media gateway assigned in each case. This can for example be the MGCP or the H.248 protocol. The Q.765.5 BAT protocol is provided between the two media gateway controllers CFS as a further standardized protocol.

A CODEC negotiation procedure is arranged in this protocol. If the useful information fed via the transmission network IP is to be compressed, the media gateway controller e.g. the CSF A informs the further media gateway controller e.g. the CSF B which compressing procedure is supported. The media gateway controller MGC B, on its part, informs the MGC A which compressing algorithm it governs and selects one of the compressing procedures offered by the MGC A. Therefore, both negotiate the compressing procedure. Each one of the media gateway controllers MGC A, MGC B control the media gateway MG A or MG B assigned to it in each case. Therefore, the data flow arriving in the media gateway MG A is compressed according to the selected compressing procedure and fed via the transmission network IP to the media gateway MG B, decompressed there and converted to a TDM data flow. Instructions on how this protocol should be used are described in the Q.1902.x BICC CS2 ITU-T Standard.

If (normal connection) the A side is in an A-law network it will only offer A-law to the B side; if in this case the B side is in a μ-law network, the B side must convert from A-law to μ-law. If the A side is in a μ-law network, it offers μ-law to the B side as first choice and A-law as an alternative second choice.

If in this case the B side is in a μ-law network, it acknowledges the ‘μ-law’ in the application transport message APM. If the B side is in an A-law network, it answers with ‘A-law’ in the application transport message APM; in this case the A side must convert from μ-law to A-law.

This is possible just like that because the media gateways have a direct interface to the TDM side in each case. With it, the coding on the TDM side of the media gateway is known. Alternatively, it is made known to the media gateway to which a call feature server MGC is assigned. In order to ensure that the A-law side (according to the specification in ITU-T) does not carry out the transcoding, a list of CODECs with at least the entry G.711 A-law is offered in the IAM according to preference.

A μ-law network prefers the G.711 μ-law CODEC, followed by a G.711 A-law CODEC as an alternative. On the other hand, an A-law network prefers the G.711 A-law CODEC.

The receiving side in its answer (according to the CODEC negotiation procedure of the BICC) based on the knowledge of whether or not it must carry out a transcoding according to the transcoding rule in ITU-T can again signal back the corresponding Codec in the selected Codec so that the transcoding rule is fulfilled.

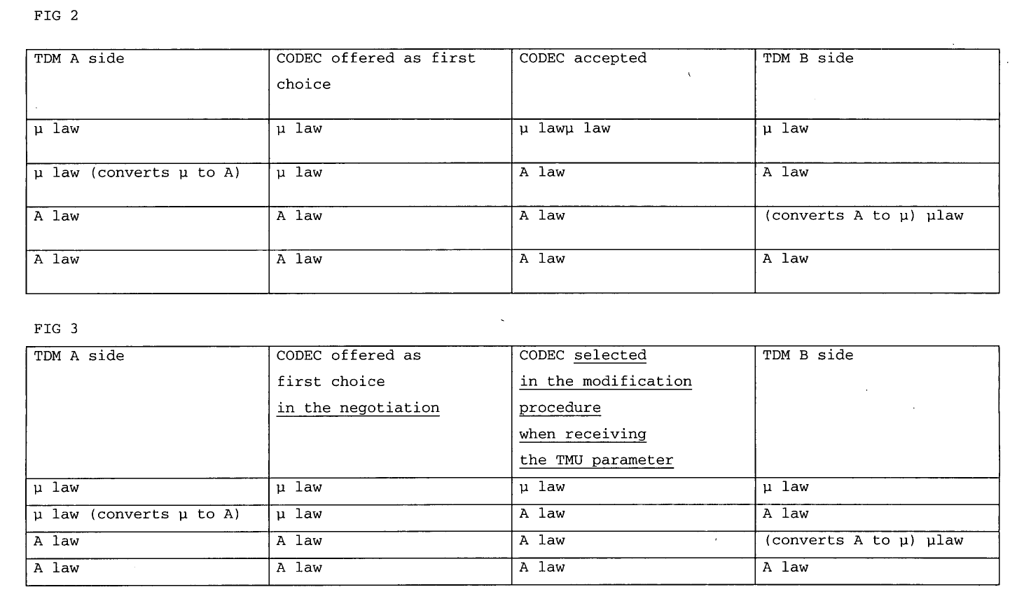

FIG. 2 is a decision table based on these deliberations.

With the information available for the call feature servers CFS A, CFS B functioning as media gateway controllers, the two media gateways MG A, MG B can then be set via the MGCP (or H.248) protocol in a corresponding way.

In order to also be able to handle the 64 kBit/s unrestricted preferred connections, a further logic is provided in the modification procedure of the Q.765.5 BAT protocol. FIG. 3 is a decision table based on these deliberations.

When establishing the connection of the 64 kBit/s unrestricted preferred connection, the negotiation procedure starts in the same way as has already been described. Although this would not be imperative for the 64 kBit/s unrestricted preferred connection, the case is indeed covered here by the fact that the connection is not established because, for example, the terminal equipment of the B user does not support this. Because it is a preferred connection, the A user also accepts connections with a lower bandwidth.

When establishing the 64 kBit/s unrestricted preferred connection, the A side neither knows which CODEC is used on the B side nor whether or not it accepts the 64 kBit/sec connection. If the A side is in an A-law network, it offers a transparent CODEC to the B side as first choice and an A-law CODEC as an alternative second choice. If the B side accepts the 64 kBit/s unrestricted preferred connection, the transparent CODEC is acknowledged in an APM message according to the CODEC negotiation.

If the A side is in an A-law network and the B side does not accept the 64 kBit/s unrestricted preferred connection, an answer is either a) given immediately to the CODEC requirement based on the decision table by using the CODEC negotiation procedure, or b) the modification procedure is initiated at a later point in time (fall back). Therefore, in case b), the A side is transmitted to the Codec modification procedure in the APM message (application transport message) based on TMU=speech (or 3.1 kHz). Implicit information about which side supports which CODEC is stored in the Codec modification. If in the case of this example, the B-side supports A-law, the A side will be informed about this, that as a result, switches over its CODEC from transparent to A-law. If the B side supports μ-law, the A side is also informed about A-law, that as a result, switches over its CODEC from transparent to A-law. The B side also switches over to A-law.

If the A side is in a μ-law network, a transparent CODEC is offered to the B side as first choice, μ-law as second choice and A-law as third choice. In the case of fall back, the CODECs are switched over in a corresponding way as has just been described.

If the A side is in a μ-law network and the B side is in an A-law network, the B side then requests the ‘A-law’ CODEC in the case of fall back.

If the A side is in an A-law network, a transparent CODEC is offered to the B side as preference and as a second choice only the A-law coded useful information is offered, whereupon the B side acknowledges the A-law CODEC if the B side identifies that the transparent CODEC is not used.

If the A side is in a μ-law network and the B side in a μ-law network, the transparent CODEC is offered to the B side as preference, μ-law as second choice and A-law as third choice, whereupon the B side acknowledges the μ-law CODEC if the B side identifies that the transparent CODEC is not used.

If the A side is in a μ-law network and the B side in an A-law network, the transparent CODEC is offered to the B side as preference, μ-law as second choice and A-law as third choice, whereupon the B side acknowledges the A-law CODEC if the B side identifies that the transparent CODEC is not used.

1.-21. (cancelled)

22. A method for exchanging useful information generated according to different coding laws between at least 2 pieces of user terminal equipment, comprising:
defining an A side according to a first coding law;
defining an B side according to a second coding law;
transmitting the useful information via a plurality of transmission units that form an interface between a first and a second transmission network and are controlled by control units;
processing signaling information assigned to the useful information by the control units, wherein the information is exchanged via a signaling protocol having a CODEC negotiation procedure; and
providing an additional logic in the CODEC negotiation procedure to convert the useful information to be exchanged according to the coding law of the receiving user terminal equipment.

23. A method according to claim 22, wherein a conversion to the coding law of the receiving user terminal equipment only takes place if the A side and the B side generate useful information according to the different coding laws.

24. A method according to claim 22, wherein the first coding law is the A-law coding law and/or the second coding law the μ-law coding law, or the first coding law is the μ-law coding law and/or the second coding law is the A-law coding law.

25. A method according to claim 22, wherein if the A side is in an A-law network and the B side in a μ-law network, only A-law coded useful information is offered to the B side, whereupon the B side converts from A-law to μ-law.

26. A method according to claim 22, wherein if the A side is in a μ-law network and the B side in a μ-law network, μ-law is offered to the B side as first choice and A-law as an alternative second choice, whereupon the B side acknowledges the ‘μ-law’ in the application transport message APM.

27. A method according to claim 22, wherein if the A side is in a μ-law network and the B side in an A-law network, μ-law is offered to the B side as first choice and A-law as an alternative second choice, whereupon the B side acknowledges the ‘A-law’ in the application transport message APM.

28. A method according to claim 22, wherein the transmission equipment is embodied as media gateway.

29. A method according to claim 22, wherein the control units are embodied as call feature servers.

30. A method according to claim 22, wherein useful information is at least in some cases exchanged package-oriented.

31. A method according to claim 22, wherein the package-oriented transmission takes place according to an IP protocol, an ATM-protocol or a frame relay protocol.

32. A method according to claim 22, wherein the signaling protocol is a BICC protocol or an extended ISUP protocol.

33. A method for exchanging useful information generated according to different coding laws between at least 2 pieces of user terminal equipment, wherein according to a first coding law an A side and according to a second coding law a B side is defined, comprising:
transmitting the useful information with a first bandwidth via a plurality of transmission units that form an interface between a first and a second transmission network and wherein the transmission units are controlled by control units;
processing signaling information assigned to the useful information by the control units, wherein the information is exchanged via a signaling protocol having a CODEC negotiation and modification procedure; and
providing a further logic in the CODEC negotiation procedure so that when switching over to a second bandwidth, the useful information to be exchanged is converted to the coding law of the receiving user terminal equipment.

34. A method according to claim 33, wherein if the A side is in an A-law network, a transparent CODEC is offered to the B side as first choice and only A-law coded useful information as an alternative second choice, whereupon the B side first of all acknowledges the transparent CODEC.

35. A method according to claim 33, wherein if the A side is in an A-law network, the B side requests the A-law CODEC in the case of fall back.

36. A method according to claim 33, wherein if the A side is in a μ-law network and the B side in a μ-law network, a transparent CODEC is offered to the B side as first choice and μ-law as second choice and A-law as third choice, whereupon the B side first of all acknowledges the transparent CODEC.

37. A method according to claim 33, wherein if the A side is in a μ-law network and the B side in a μ-law network, the B side requests the ‘μ-law’CODEC in the case of fall back.

38. A method according to claim 33, wherein if the A side is in a μ-law network and the B side in an A-law network, a transparent CODEC is offered to the B side as first choice and μ-law as second choice and A-law as third choice, whereupon the B side first of all acknowledges the transparent CODEC.

39. A method according to claim 33, wherein if the A side is in a μ-law network and the B side in an A-law network, the B side requests the ‘A-law’ CODEC in the case of fall back.

40. A method according to claim 33, wherein if the A side is in an A-law network, a transparent CODEC is offered to the B side as first choice and only A-law coded useful information as an alternative second choice, whereupon the B side acknowledges the A-law CODEC if the B side identifies that the transparent CODEC is not used.

41. A method according to claim 33, wherein if the A side is in a μ-law network and the B side in a μ-law network, a transparent CODEC is offered to the B side as first choice and μ-law as second choice and A-law as third choice, whereupon the B side acknowledges the μ-law CODEC if the B side identifies that the transparent CODEC is not used.

42. A method according to claim 33, wherein if the A side is in a μ-law network and the B side in an A-law network, a transparent CODEC is offered to the B side as first choice and μ-law as second choice and A-law as third choice, whereupon the B side acknowledges the A-law CODEC if the B side identifies that the transparent CODEC is not used.
